(19) United States
(12) Patent Application Publication
(10) Pub. No.: US 2010/0259510 A1
(43) Pub. Date: Oct. 14, 2010

(54) Apparatus for data encoding in LCD Driver

(75) Inventor: Ching-Chung Lee, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX TECHNOLOGIES LIMITED, Tainan (TW)

(21) Appl. No.: 12/421,790

(22) Filed: Apr. 10, 2009

(51) Int. Cl. G06F 3/038

(52) U.S. Cl. 345/204

(57) ABSTRACT

A source driver includes an external data bus and a receiver configured to receive data signals from the external data bus, the receiver having an encoder configured to encode the data signals and output encoded signals such that a toggling rate of the encoded signals is less than a toggling rate of the data signals, an internal data bus configured to transmit the encoded signals, and a plurality of driving channels configured to receive the encoded signals from the internal data bus and to output driving voltages.

### BACKGROUND

1. Technical Field

The embodiments described herein relate to liquid crystal display (LCD) drivers, and more particularly, to drivers for LCD devices having low power consumption and electromagnetic interference (EMI).

2. Related Art

As the need for small-size display panels for portable electronic devices and large-size display panels for home applications steadily increases, power consumption and EMI become significant performance issues. For an LCD driver of a small-sized display panel, power consumption is problematic. Conversely, for an LCD driver of a large-sized display panel, EMI is problematic because of the increasing layout size of the LCD driver. Accordingly, there is a need for an LCD driver with low power consumption and EMI.

Conventionally, solutions to reduce power dissipation and EMI generation in a flat panel display system have included splitting the pixel data into two buses, each operating at half the data rate. However, this technique requires additional wires to transmit the pixel data and the pixel clock signals. Moreover, although slower transition edges are obtained, which can be effective in reducing EMI, the introduction of an additional data bus actually increases power dissipation and reduces noise immunity.

Furthermore, data transitions on the data bus may be reduced by employing a multiplexed reduced swing differential signaling scheme in combination with one or more data transmission schemes to transmit video data. A control circuit using reduced swing differential time multiplexed signals is disclosed by Joseph in U.S. Pat. No. 6,356,260 B1. However, this requires an additional multiplexed data bus and the horizontal or vertical repeatability of video data. Thus, there is a need for an apparatus that can reduce power dissipation and EMI generation in a flat panel display system without a surplus of additional devices and the limitation on inputted video data.

### SUMMARY

An LCD driver capable of providing low power consumption and electromagnetic interference is described herein.

In one aspect, a source driver includes an external data bus and a receiver configured to receive data signals from the external data bus, the receiver having an encoder configured to encode the data signals and output encoded signals such that a toggling rate of the encoded signals is less than a toggling rate of the data signals, an internal data bus configured to transmit the encoded signals, and a plurality of driving channels configured to receive the encoded signals from the internal data bus and to output driving voltages.

In another aspect, a liquid crystal display driver includes a timing controller configured to receive data signals and to output control signals, the timing controller having an encoder configured to encode the data signals and to output the control signals such that a toggling rate of the control signals is less than a toggling rate of the data signals, an external data bus configured to transmit the control signals, and a source driver configured to receive the control signals from the external data bus and to output driving voltages.

In another aspect, a driver for a liquid crystal display device includes an encoder configured to encode data signals and to output control signals such that a toggling rate of the control signals is less than a toggling rate of the data signals, an external data bus configured to transmit the control signals, an internal data bus configured to receive the control signals from the external data bus and to transmit the control signals, and a plurality of driving channels configured to receive the control signals from the internal data bus and to output driving voltages, wherein each of the driving channels includes a decoder configured to convert the encoded signals into the driving voltages.

At least one advantage of the embodiments described herein is the ability to transmit signals through the data bus with a lower toggling rate. Accordingly, power dissipation and EMI on the data bus can be reduced.

These and other features, aspects, and embodiments are described below in the section “Detailed Description.”

### BRIEF DESCRIPTION OF THE DRAWINGS

Features, aspects, and embodiments are described in conjunction with the attached drawings, in which:

FIG. 1 is a schematic block diagram of exemplary power consumption induced in a data bus according to one embodiment;

FIG. 2 is a schematic block diagram of an exemplary LCD driver according to one embodiment; and

FIG. 3 is a schematic block diagram of an exemplary source driver according to one embodiment.

### DETAILED DESCRIPTION

In a high-resolution flat panel display, such as a flat panel display system, the data bus dissipates a significant amount of power and generates a large amount of EMI. Power dissipation is high because most existing displays use TTL voltage levels (3.3 volt CMOS) to transmit pixel data. In addition, high data rates and sharp transition edges generate significant EMI.

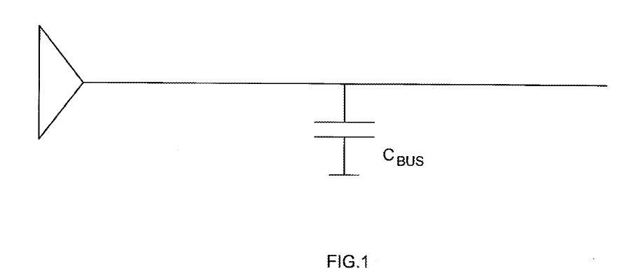

FIG. 1 is a schematic block diagram of exemplary power consumption induced in a data bus according to one embodiment. In FIG. 1, the data bus of an LCD driver may be several inches long, thus inducing a substantial parasitic capacitor C_{Bus}. When a signal current passes through the data bus, it will charge and discharge the parasitic capacitor each time it switches state, i.e., high to low voltage level. The signal current induces a substantial amount of EMI each time it switches state, given the sharp edge of its waveform. In the following description, the term “toggling rate” is defined as the percentage of the clock frequency at which the signal current switches. It has values in the range of 0% to 100%, where 0% yields a static voltage level of the signal current and 100% yields ½ of the clock frequency.

Since the parasitic capacitor C_{Bus} is determined by the length of the data bus, which is fixed according to the size of the flat panel display, a more effective technique to reduce power dissipation and EMI is by reducing the toggling rate of the signal transmitted through the data bus.

Accordingly, a Gray code may be utilized to encode original data signals into encoded signals with a much lower toggling rate. There is only one bit location different between numeric increments in a Gray code. Advantageously, for real switches to change states, it only has to change one switch at a time. Thus, a much smaller toggling rate than the original data signals coded in the binary code can be obtained. For high resolution display, the pixels of a picture frame usually change their color level gradually. For text screen, the pixels of a picture frame consist mostly of color level, either mostly bright or mostly dark. For the dithering technique for space and time domains, each of the pixels of an image frame may differ by only one or two codes. Use of the Gray code can effectively reduce the toggling rate of the original signals. However, a variety of coding schemes may be utilized to encode the data signals as long as the encoded signals have a toggling rate that is less than that of the original data signals.

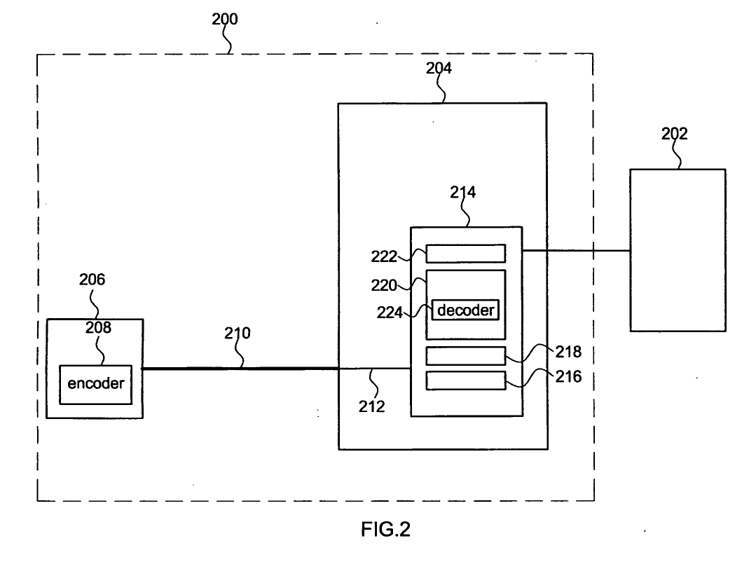

FIG. 2 is a schematic block diagram of an exemplary LCD driver according to one embodiment. In FIG. 2, an LCD driver 200 can produce analog voltages to drive an LCD panel 202 to produce the desired grey scale or color images. For example, the LCD panel 202 may be a 1920 pixels wide by 1080 lines high VGA color TFT panel.

The LCD driver can be configured to include a source driver 204 and a gate driver (not shown) to drive the columns and rows of the LCD panel 202, respectively. The source driver 204 can output driving voltages to support the LCD panel 202 and drive lines of pixels on the LCD panel 202. The gate driver can drive the rows of LCD panel, and can be activated sequentially to turn ON rows of pixels at a time, thereby allowing analog voltages driven onto the columns to be applied to each row of pixels in a series.

The LCD driver 200 can further include a timing controller 206 configured to receive data signals and output control signals. For example, the timing controller 206 can include a controller IC that can produce timing control signals, also called video data or pixel data, herein defined as control signals. The timing controller 206 can receive digital display data from a receiver, which can receive digital video data that may come from a media player (not shown). According to the digital video data, the timing controller 206 can generate control signals to the source driver 204 and the gate driver.

The timing controller 206 can further include an encoder 208 such that the control signals are encoded, wherein a toggling rate of the control signals can be less than a toggling rate of the data signals. As mentioned before, the encoder may be, but is not limited to, a Gray code encoder that can encode binary coded data as Gray coded data.

The LCD driver 200 can be configured to include an external data bus 210 for transmitting the control signals to the source driver 204. The source driver 204 can further include an internal data bus 212 for transmitting the control signals internally.

For example, the source driver 204 can be configured to include one or more driving channels 214 for receiving the control signals from the internal data bus 212 and outputting driving voltages. Each of the driving channels 214 can further include a register 216, a level shifter 218, a DAC 220, and an output buffer 222. Preferably, a decoder 224 is embedded in the DAC 220, which then converts the encoded signals into analog driving voltages. The decoder 224 decodes the encoded signals into original data signals, which are subsequently processed by the DAC 220. Through proper arrangement of the input gates, the DAC 220 will not require additional costs to embed the decoder 224. Moreover, the decoder 224 may be implemented between the DAC 220 and the level shifter 218, or between the register 216 and the level shifter 218, depending on the needs of the circuit design.

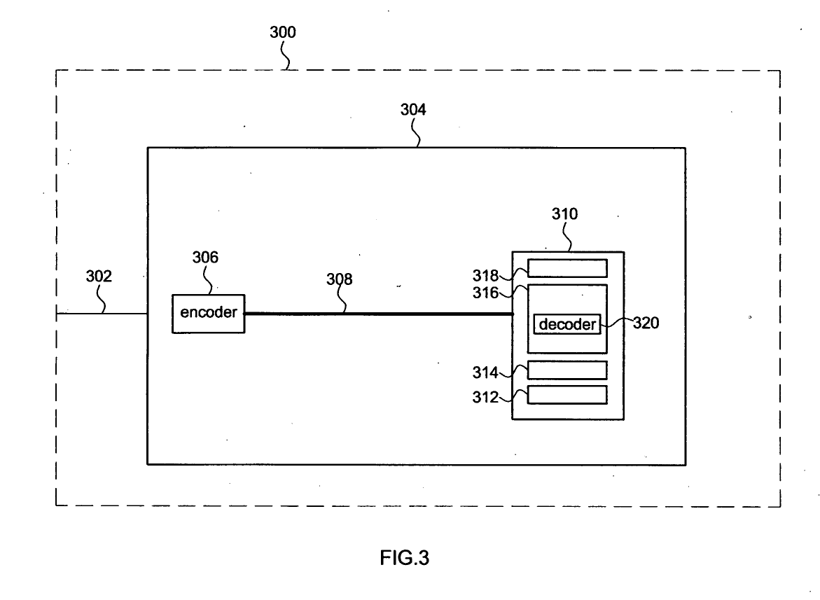

FIG. 3 is a schematic block diagram of an exemplary source driver according to one embodiment. In FIG. 3, the source driver 300 can be configured to receive data signals from a timing controller (not shown) and can output a driving voltage to drive lines of pixels on an LCD panel (not shown).

The source driver 300 can include an external data bus 302 and a receiver 304 for receiving data signals from the external data bus 302. For example, the receiver 304 can include an encoder 306 configured to encode the data signals and output encoded signals such that a toggling rate of the encoded signals is less than a toggling rate of the data signals. In addition, the receiver 304 can include an internal data bus 308 for transmitting the encoded signals.

In FIG. 3, the receiver 304 can further include one or more driving channels 310 for receiving the encoded signals from the internal data bus 308 and outputting driving voltages. Each of the driving channels 310 can include a register 312, a level shifter 314, a digital to analog converter (DAC) 316, and an output buffer 318. Preferably, a decoder 320 is embedded in the DAC 316, which then converts the encoded signals into analog driving voltages. Here, the decoder 320 can decode the encoded signals into original data signals, which are subsequently processed by the DAC 316. Through proper arrangement of the input gates, the DAC 316 will not require additional costs to embed the decoder 320. Moreover, the decoder 320 may be implemented between the DAC 316 and the level shifter 314, or between the register 312 and the level shifter 314, depending on the needs of the circuit design.

As shown in FIGS. 2 and 3, almost all of the signals flowing in the LCD driver 200 or the source driver 300 can be encoded during transmission on the data buses. Accordingly, the toggling rate of signals in the LCD driver 200 or the source driver 300 may be substantially reduced, thereby reducing power dissipation and EMI generation without a surplus of additional devices and placing limitations on input video data. Preferably, original data are encoded in a timing controller 206 (in FIG. 2), and the source driver 214 will not require additional costs. Moreover, although the encoder 208 or 306 and the decoder 224 or 320 can be implemented in specific locations, the encoder 208 or 306 and the decoder 224 or 320 may be deployed in any location of the LCD driver 200 or source driver 300, as long as the average toggling rate of signal passing through the LCD driver 200 or source driver 300 can be reduced.

While certain embodiments have been described above, it will be understood that the embodiments described are by way of example only. Accordingly, the device and methods described herein should not be limited based on the described embodiments. Rather, the device and methods described herein should only be limited in light of the claims that follow when taken in conjunction with the above description and accompanying drawings.

What is claimed is:

1. A source driver, comprising:
an external data bus; and
a receiver configured to receive data signals from the external data bus, the receiver comprising:
an encoder configured to encode the data signals and output encoded signals such that a toggling rate of the encoded signals is less than a toggling rate of the data signals;
an internal data bus configured to transmit the encoded signals; and
a plurality of driving channels configured to receive the encoded signals from the internal data bus and to output driving voltages.

2. The source driver of claim 1, wherein each of the driving channels further comprises a decoder configured to decode the encoded signals.

3. The source driver of claim 1, wherein each of the driving channels further comprises a DAC embedded with the decoder configured to convert the encoded signals into the driving voltages.

4. The source driver of claim 1, wherein the data signals are coded in a binary code.

5. The source driver of claim 1, wherein the encoded signals are coded in a Gray code.

6. A liquid crystal display driver, comprising:
a timing controller configured to receive data signals and to output control signals, the timing controller comprising:
an encoder configured to encode the data signals and to output the control signals such that a toggling rate of the control signals is less than a toggling rate of the data signals;
an external data bus configured to transmit the control signals; and
a source driver configured to receive the control signals from the external data bus and to output driving voltages.

7. The liquid crystal display driver of claim 6, wherein the source driver further comprises:
an internal data bus configured to transmit the control signals; and
a plurality of driving channels configured to receive the control signals from the internal data bus and to output the driving voltages.

8. The liquid crystal display driver of claim 6, wherein each of the driving channels further includes a decoder configured to decode the control signals.

9. The liquid crystal display driver of claim 6, wherein each of the driving channels further includes a DAC embedded with the decoder configured to convert the encoded signals into the driving voltages.

10. The liquid crystal display driver of claim 6, wherein the data signals are coded in a binary code.

11. The liquid crystal display driver of claim 6, wherein the control signals are coded in a Gray code.

12. A driver for a liquid crystal display device, comprising:
an encoder configured to encode data signals and to output control signals such that a toggling rate of the control signals is less than a toggling rate of the data signals;
an external data bus configured to transmit the control signals;
an internal data bus configured to receive the control signals from the external data bus and to transmit the control signals; and
a plurality of driving channels configured to receive the control signals from the internal data bus and to output driving voltages,
wherein each of the driving channels includes a decoder configured to convert the encoded signals into the driving voltages.

13. The driver of claim 12, wherein the control signals are coded in one of a binary code and a Gray code.
